(19) United States
(12) Patent Application Publication
(10) Pub. No.: US 2026/0163621 A1
(43) Pub. Date: Jun. 11, 2026

(54) STEERING GAIN COMPENSATION FOR SPACE-FREQUENCY ADAPTIVE PROCESSING BEAMFORMING

(71) Applicant: BAE Systems Information and Electronic Systems Integration Inc., Nashua, NH (US)

(72) Inventor: Aaron P. Shaffer, Cedar Rapids, IA (US)

(73) Assignee: BAE Systems Information and Electronic Systems Integration Inc., Nashua, NH (US)

(21) Appl. No.: 18/976,954

(22) Filed: Dec. 11, 2024

(51) Int. Cl. H04B 7/06

(52) U.S. Cl. CPC H04B 7/0617; H04B 7/0634

(57) ABSTRACT

Techniques are provided for steering gain compensation for space-frequency adaptive processing (SFAP) beamforming systems. A system implementing the techniques according to an embodiment includes a normalized steering gain (NSG) calculator configured to calculate an NSG at each of a plurality of frequencies. The NSG is based on steering constraints provided to an SFAP beamformer and on beamforming weights generated by the SFAP beamformer. The system also includes an NSG inverter configured to calculate an inverse of the NSG, at each of the plurality of frequencies. The system further includes an NSG compensator configured to multiply an output of the SFAP beamformer with the inverse of the NSG to generate a steering gain compensated beamformer output, at each of the plurality of frequencies.

### FIELD OF DISCLOSURE

The present disclosure relates to beamforming, and more particularly to steering gain compensation (SGC) for space-frequency adaptive processing (SFAP) beamforming systems.

### BACKGROUND

Beamforming systems use antenna arrays to improve signal reception by steering nulls in the direction of jamming signals while steering gain towards signals of interest. The amount of gain that can be steered toward the signal of interest can vary depending on the jamming environment. In some circumstances, for example under partial frequency band jamming conditions, the gain can vary significantly over frequency resulting in distortion of the signal of interest.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an implementation of a beamforming receiver configured to provide SGC, in accordance with certain embodiments of the present disclosure.

FIG. 2 is a block diagram of the SFAP beamformer of FIG. 1, configured in accordance with certain embodiments of the present disclosure.

FIG. 3 is a plot illustrating beamforming performance, in accordance with certain embodiments of the present disclosure.

FIG. 4 is a block diagram of the signal decoder of FIG. 1, configured in accordance with certain embodiments of the present disclosure.

FIG. 5 illustrates beamforming signal power spectra without SGC, in accordance with certain embodiments of the present disclosure.

FIG. 6 illustrates plots showing decoder performance without SGC, in accordance with certain embodiments of the present disclosure.

FIG. 7 is a block diagram of the SGC system of FIG. 1, configured in accordance with certain embodiments of the present disclosure.

FIG. 8 illustrates plots showing normalized steering gain (NSG) and SGC, in accordance with certain embodiments of the present disclosure.

FIG. 9 illustrates beamforming signal power spectra with SGC, in accordance with certain embodiments of the present disclosure.

FIG. 10 illustrates plots showing decoder performance with SGC, in accordance with certain embodiments of the present disclosure.

FIG. 11 is a flowchart illustrating a methodology for providing SGC, in accordance with an embodiment of the present disclosure.

FIG. 12 is a block diagram of a processing platform configured to provide SGC, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for steering gain compensation for space-frequency adaptive processing (SFAP) beamforming systems under partial frequency band jamming conditions. In some embodiments, the techniques can be used to reduce pseudo range bias for global positioning system (GPS) signals.

As noted above, beamforming systems use antenna arrays to improve signal reception by steering nulls in the direction of jamming signals while steering gain towards signals of interest. The amount of gain that can be steered toward the signal of interest can vary depending on the jamming environment. In some circumstances, for example under partial frequency band jamming conditions (e.g., where the bandwidth of the jammer differs from the bandwidth of the signal of interest), the gain can vary significantly over frequency resulting in distortion or frequency notching of the signal of interest. For GPS signals, this can result in distortion of the correlation and code discriminator functions applied to the post-beamforming signal, which in turn can lead to biases or errors in the GPS pseudo range measurements.

To this end, and in accordance with an embodiment of the present disclosure, techniques are provided to use a normalized steering gain (NSG) metric as an indicator of the beamforming gain, as a function of frequency. An inverse of the NSG can then be applied to the output of the beamformer to compensate for (e.g., remove or reduce) the beamformer induced frequency notching in the GPS signal spectrum, at the cost of reduce signal to noise ratio (SNR).

In accordance with an embodiment, a system implementing the techniques according to an embodiment includes an NSG calculator configured to calculate an NSG at each of a plurality of frequencies. The NSG is based on steering constraints provided to an SFAP beamformer and on beamforming weights generated by the SFAP beamformer. The system also includes an NSG inverter configured to calculate an inverse of the NSG, at each of the plurality of frequencies. The system further includes an NSG compensator configured to multiply an output of the SFAP beamformer with the inverse of the NSG to generate a steering gain compensated beamformer output, at each of the plurality of frequencies.

It will be appreciated that the techniques described herein may allow for a tradeoff between beamformer induced distortion versus SNR, under conditions of partial frequency band jamming. Numerous embodiments and applications will be apparent in light of this disclosure.

### System Architecture

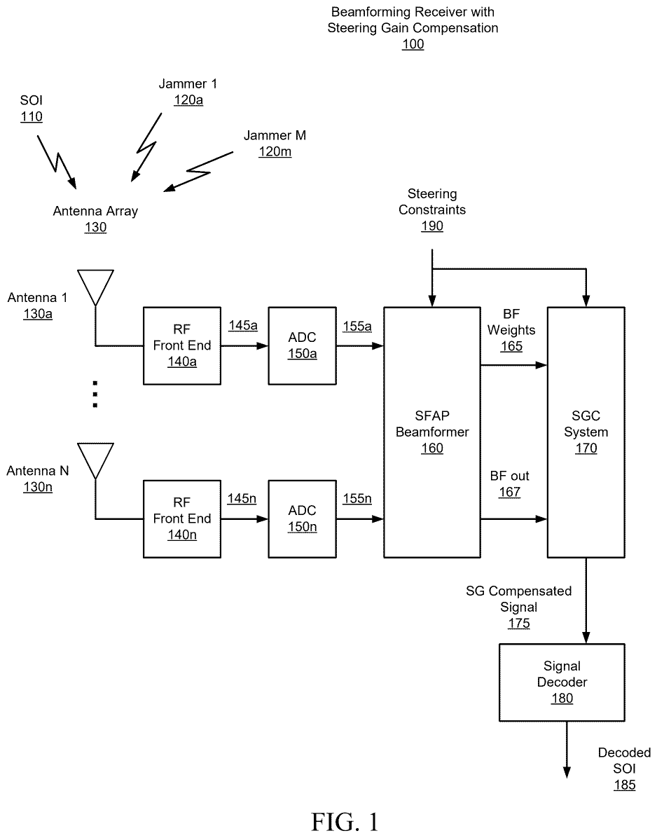

FIG. 1 illustrates an implementation of a beamforming receiver 100 configured to provide SGC, in accordance with certain embodiments of the present disclosure. The beamforming receiver 100 is shown to include an antenna array 130, a radio frequency (RF) front end 140, analog to digital converters (ADCs) 150, an SFAP beamformer 160, an SGC system 170, and a signal decoder 180.

The antenna array 130 comprises N antenna elements (e.g., antenna 1 130a, . . . antenna N 130n) configured to receive RF signals from any number of sources. The RF signals may, for example, include a signal of interest (SOI) 110 as well as jammer signals from one or more jammers (e.g., jammer 1 120a, . . . jammer N 120m). In some embodiments, the SOI 110 is a GPS signal.

The RF front ends 140a, . . . 140n are coupled to the antennas 130a, . . . 130n and, in some embodiments, are configured to convert the received RF signals down to an intermediate frequency (IF) signal or a baseband analog signal and perform any suitable filtering and amplification.

The ADCs 150a, . . . 150n are configured to convert the analog signals 145a, . . . 145n, generated by the RF front ends, into N digital signal channels 155a, . . . 155n comprising complex valued in-phase and quadrature data samples (IQ data) to be provided to the SFAP beamformer 160.

The SFAP beamformer 160 is configured to perform space-frequency adaptive processing beamforming to steer nulls in the direction of jammers 120 and to steer a beam (providing gain) in the direction of the SOI 110.

Operation of the SGC system 170 will be described in greater detail below, but at a high level, the SGC system is configured to provide steering gain compensation, under partial frequency band jamming conditions, to reduce distortion of the SOI by the beamformer.

The signal decoder 180 is configured to decode the SOI embedded in the steering gain compensated signal 175. The decoded SOI 185 may then be provided to downstream processors to perform application specific tasks based on the decoded signal.

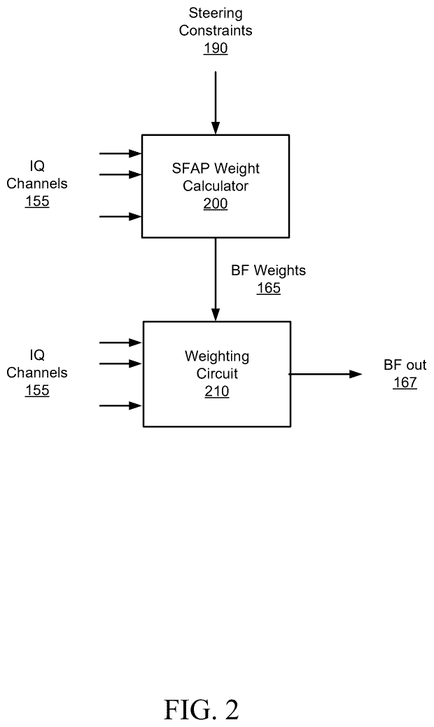

FIG. 2 is a block diagram of the SFAP beamformer 160 of FIG. 1, configured in accordance with certain embodiments of the present disclosure. SFAP beamformer 160 is configured to employ any suitable space-frequency adaptive processing beamforming algorithm to steer nulls in the direction of the jammers 120 and to steer a beam in the direction of the SOI 110 based on provided steering constraints. The SFAP beamformer 160 is shown to include an SFAP weight calculator 200 and a weighting circuit 210.

The SFAP weight calculator 200 is configured to calculate N beamforming weights 165, one for each of the N digital signal channels 155a, . . . 155n (associated with the N antenna elements), for each of a plurality of frequency bins that cover a frequency range of interest. The weights 165 are based on the IQ channel data 155 and the steering constraints 190 which specify the desired location to which the beam should be steered (e.g., the location of the SOI). In some embodiments, the weights are calculated using a power minimization process, although other suitable techniques may be used.

The weighting circuit 210 is configured to apply the complex valued beamforming weights 165 to the IQ data on the digital signal channels 155. In some embodiments, the weighting circuit 210 multiples the IQ data by the weights 165 (for each frequency bin) and then sums the resulting weighted channels to produce the beamformer output 167 (for each frequency bin).

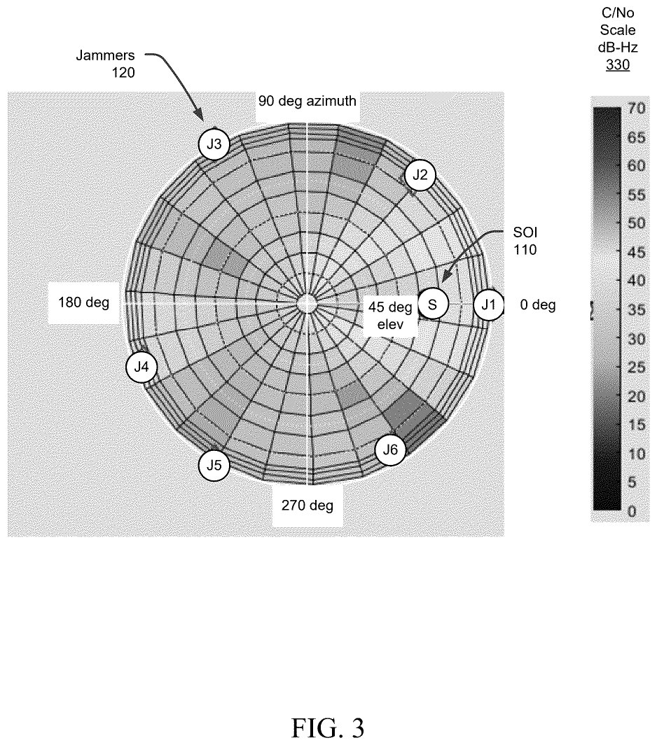

FIG. 3 is a plot illustrating beamforming performance 300, in accordance with certain embodiments of the present disclosure. The plot shows six jammers 120, labeled “J1” through “J6,” at various azimuths and at elevation angles of zero degrees (e.g., on or near the horizon). The plot also shows a SOI, labeled “S” at azimuth angle zero degrees and elevation angle 45 degrees. The beamforming performance is depicted as color coded SNR (C/No on a unit bandwidth scale e.g., dB-Hz). A color coded legend 330 is provided to map the colors to dB-Hz values. So, for example, the SNR is in the 40-45 dB-Hz range in the direction of the SOI, while the SNR is lower (25-35 dB-Hz) in the direction of jammers J2 through J6. Jammer J1, however, is located in approximately the same azimuth direction as the SOI and is therefore within the beam that would be steered towards the SOI. Attempts to null jammer J1 can therefore cause distortion of the SOI.

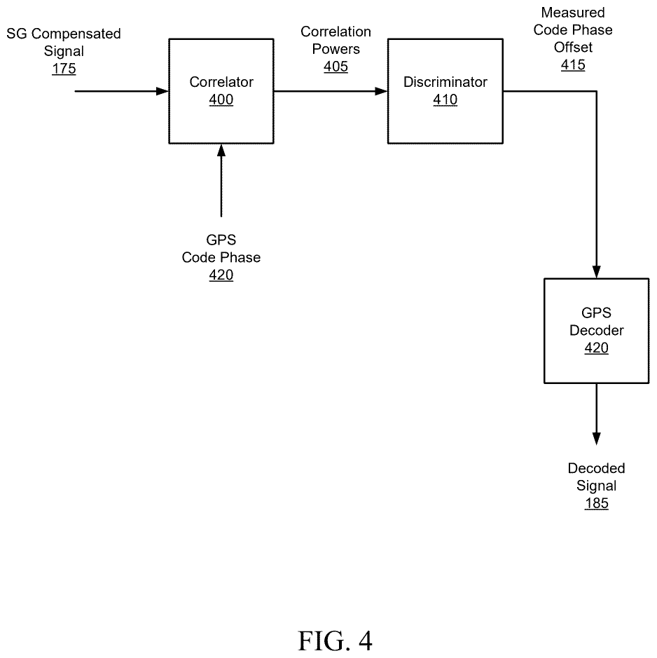

FIG. 4 is a block diagram of the signal decoder 180 of FIG. 1, configured in accordance with certain embodiments of the present disclosure. The signal decoder 180 in this example is configured to decode a GPS signal as the signal of interest and is shown to include a correlator 400 and a discriminator 410.

The correlator 400 is configured to operate on the SG compensated signal 175 to correlate the signal to a GPS code phase 420 over a range of phase offsets.

The discriminator 410 is configured to compare the correlation powers 405, generated by the correlator 400, at the different phase offsets to determine the code phase offset 415 for the GPS signal embedded in the SG compensated signal 175. In some embodiments, the discriminator 410 employs an early minus late differencing function where power from a late correlator tap is subtracted from an early correlator tap. The measured code phase offset 415 is determined by the location where the difference function exhibits a zero crossing.

For other signals of interest (signals other than GPS signals), different types of decoders may be employed which are configured to perform different decoding functions on the SG compensated signal 175.

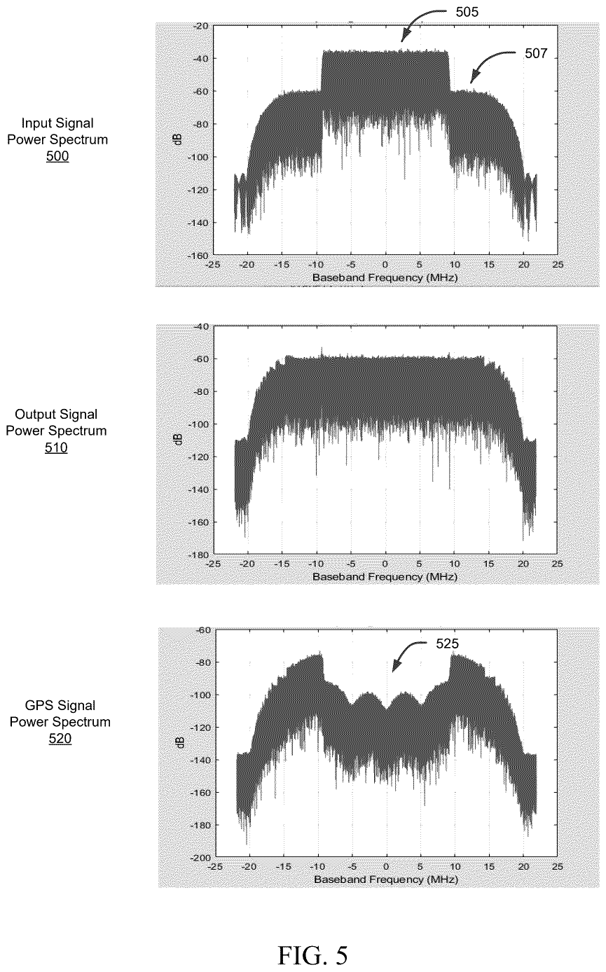

FIG. 5 illustrates beamforming signal power spectra without SGC, in accordance with certain embodiments of the present disclosure. The figure shows beamformer input signal power spectrum 500, beamformer output signal power spectrum 510 without SGC, and a GPS signal power spectrum 520 after beamforming without SGC.

The power spectrum 500 of the input signal to the beamformer shows jammer power 505 covering a frequency range of approximately −9 MHz to +9 MHz at a power level of approximately −35 dB. Also shown is noise 507, which includes an embedded GPS signal below the noise floor, covering a frequency range of approximately −16 MHz to +16 MHz at a power level of approximately −60 dB.

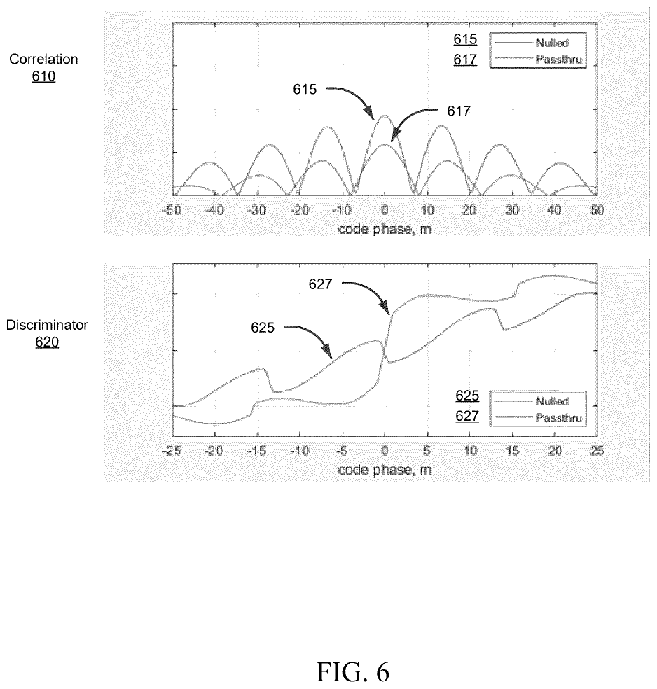

The power spectrum 510 of the output of the beamformer, without using SGC techniques disclosed below, shows that the jammer 505 has been removed. However, the underlying GPS signal, at −80 dB, exhibits a notch 525 imposed by the beamformer. This notch, of approximately 20 dB brings the GPS signal down to approximately −100 dB and extends over the frequency range (−9 MHz to +9 MHz) of the jammer that is being nulled at the same azimuth as the GPS signal source. Notching of the GPS signal can adversely affect the decoding of that signal as described below in connection with FIG. 6.

FIG. 6 illustrates plots showing decoder performance 600 without SGC, in accordance with certain embodiments of the present disclosure. The figure shows the resulting correlation function 610 and discriminator function 620 generated by the signal decoder 180 for the non-SGC use case.

The first plot 610 shows the correlation function 617 without beamforming or jamming (e.g., passthrough) along with the correlation function 615 under jamming conditions after beamforming without SGC. These plots show that the beamformer increases gain on the SOI (e.g., the correlation peaks are higher), however, the beamforming without SGC shifts the locations of the correlation peaks and zeros, which has an adverse effect on the discriminator function as shown in the second plot 620.

The second plot 620 shows the discriminator output 627 without beamforming or jamming (e.g., passthrough) along with the discriminator output 625 under jamming conditions after beamforming without SGC. Code phase detectors determine the code phase based on the location of the zero crossing of the discriminator function. As can be seen here, the discriminator function 625 (e.g., beamforming without SGC) produces three zero crossings (at code phase m=−4, m=0, and m=+4) which can cause the detector to lock in on the wrong code phase. In the case of a GPS signal this can results in pseudo range bias or other measurement errors.

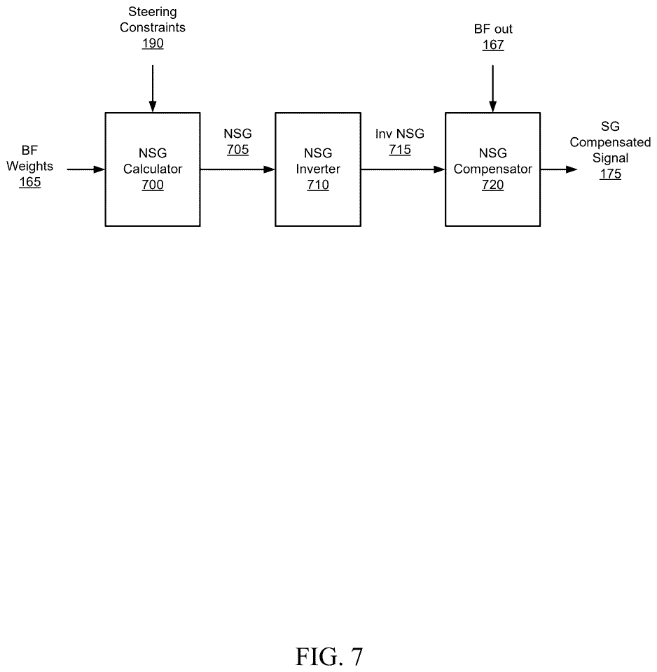

FIG. 7 is a block diagram of the SGC system 170 of FIG. 1, configured in accordance with certain embodiments of the present disclosure. The SGC system 170 is shown to include an NSG calculator 700, and NSG inverter 710, and an NSG compensator 720.

The NSG calculator 700 is configured to calculate the NSG 705, at each of a plurality of frequencies, based on the steering constraints 190 provided to the SFAP beamformer 160 and on the beamforming weights 165 generated by the SFAP beamformer. In some embodiments, the plurality of frequencies spans a frequency range associated with jamming signals to be nulled by the SFAP beamformer.

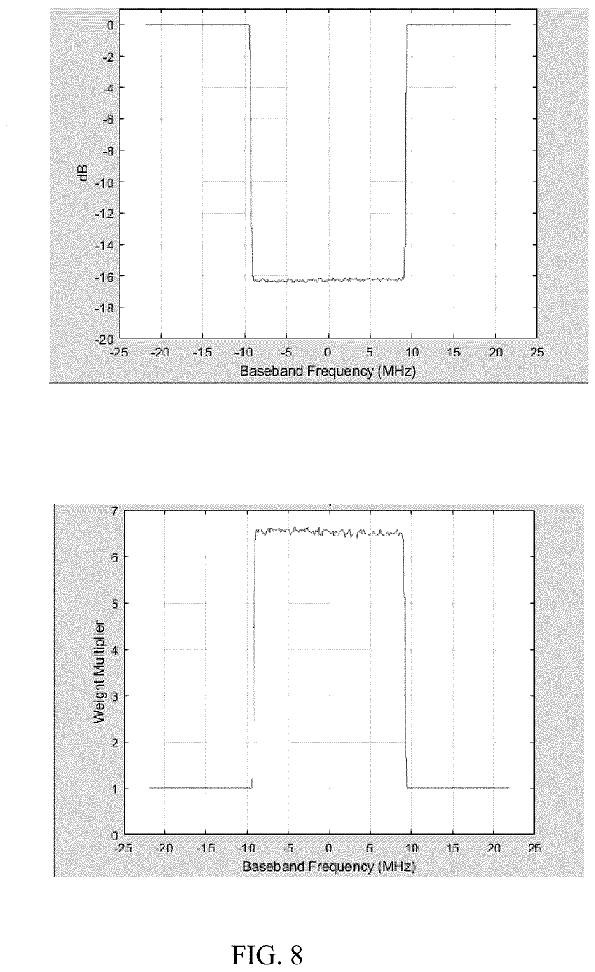

An example NSG 800 is illustrated in FIG. 8. The NSG indicates the directional gain provided by the beamformer across frequency. It shows that in frequency bins where the jammer is not present, the gain can be relatively high, while in frequency bins occupied by the jammer (the central region) the beamformer cannot steer gain in the desired direction (e.g., the NSG is lower). The plot of NSG 800 shows dB relative to a maximum gain (e.g., 0 dB corresponds to maximum gain). Said differently, the NSG provides a metric for how well the beamforming weights align with the direction to the source of the SOI (e.g., a GPS satellite), which indicates the amount of gain that can be realized in the direction of the SOI.

In some embodiments, the NSG is calculated as the magnitude of the dot product of the steering constraint vector representing the steering constraints and the beamforming weight vector representing the beamforming weights, which is then normalized by the vector norm of the steering constraint vector and the vector norm of the beamforming weight vector. This may be expressed as:

$${NSG}_{f} = ( \vert {W}_{f} \cdot {C}_{f} \vert ) / ( ‖ {W}_{f} ‖ * ‖ {C}_{f} ‖ )$$

where:
NSG_{f} is the normalized steering gain for a frequency bin f,
W_{f} is the complex beamforming weight vector of length N for a frequency bin f,
C_{f} is the complex steering constraint vector of length N for a frequency bin f, and
N is the number of antenna elements in the antenna array

The NSG inverter 710 is configured to calculate the inverse of the NSG 715, at each of the plurality of frequencies. The inverse NSG serves as the steering gain compensation. An example SGC 810 is illustrated in FIG. 8.

The NSG compensator 720 is configured to multiply the output of the SFAP beamformer 167 with the inverse of the NSG 715 to generate a steering gain compensated beamformer output 715, at each of the plurality of frequencies.

In some embodiments, the inverse of the NSG may be scaled by a scale factor that is selected to achieve a tradeoff between the beamforming gain on the SOI versus the suppression of jamming signals, which is equivalent to a tradeoff between SNR and beamformer induced signal distortion. In some embodiments, the scale factor is frequency dependent. In some embodiments, the scale factor may be determined empirically, for example based on the application, the type of signal of interest, and/or types of jammers. In some embodiments, the scale factor may be provided as feedback from a down stream application that employs the decoded signal 185 and needs to adjust the scale factor to meet performance requirements.

FIG. 8 illustrates plots showing NSG 800 and SGC 810, in accordance with certain embodiments of the present disclosure. In this example, the NSG 800 is shown to provide an approximately 16 dB attenuation over the frequency range of the jammer from −9 MHz to +9 MHz. The corresponding SGC 810 is shown as a beamforming weight multiplier (on a linear scale) of approximately 6.5 over that same frequency range.

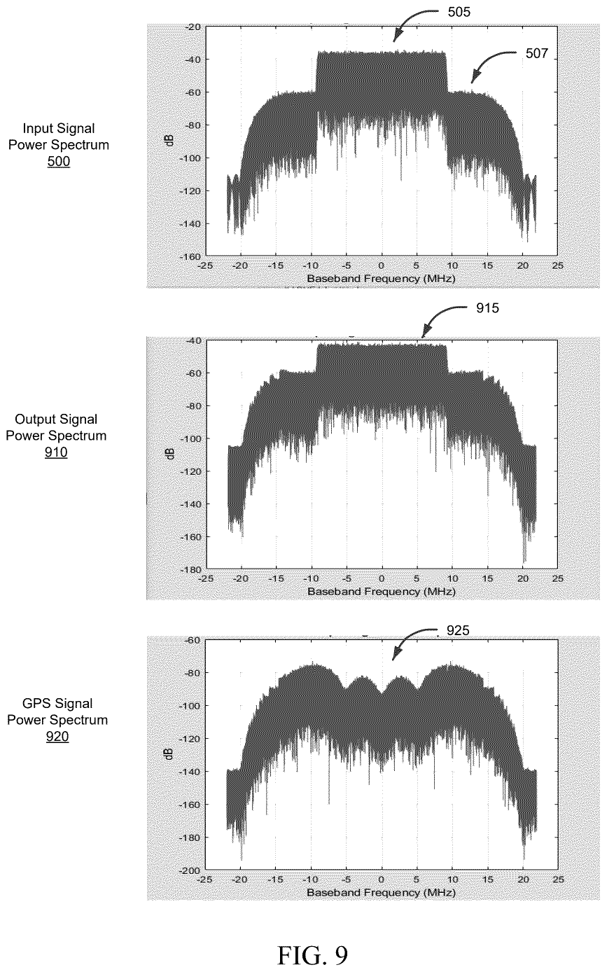

FIG. 9 illustrates beamforming signal power spectra with SGC, in accordance with certain embodiments of the present disclosure. The figure shows the beamformer input signal power spectrum 500, the beamformer output signal power spectrum 910 with SGC, and a GPS signal power spectrum 920 after beamforming with SGC.

As previously illustrated in FIG. 5, the power spectrum 500 of the input signal to the beamformer shows jammer power 505 covering a frequency range of approximately −9 MHz to +9 MHz at a power level of approximately −35 dB. Noise 507 is also shown, which includes an embedded GPS signal below the noise floor, covering a frequency range of approximately −16 MHz to +16 MHz at a power level of approximately −60 dB.

The power spectrum 910 of the output of the beamformer, using SGC, shows that the beamformed jammer 915 has been reduced from −35 dB down to −45 dB. This is less reduction than the non-SGC case, however, the underlying beamformed GPS signal 920 has not been as severely notched as in the non-SGC case. The notch 925 of the SGC beamformed GPS signal is now at approximately −80 dB as opposed to the level of −100 dB for the non-SGC case.

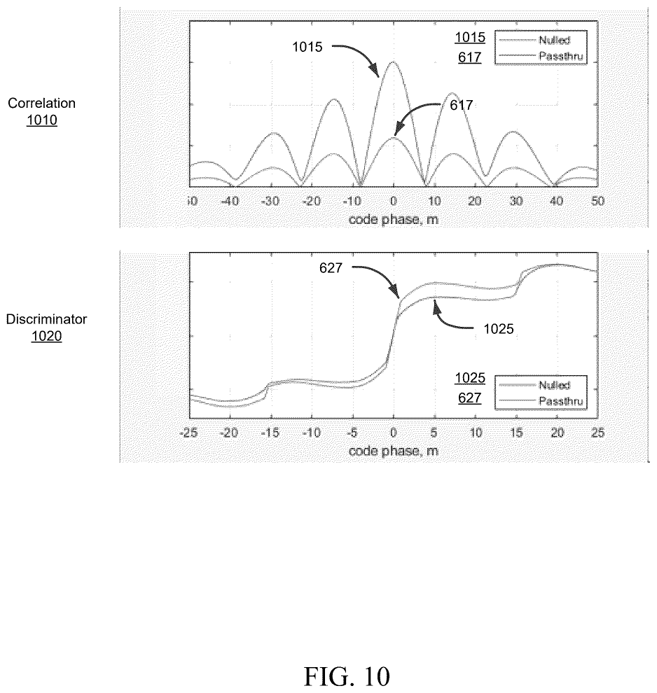

FIG. 10 illustrates plots showing decoder performance 1000 with SGC, in accordance with certain embodiments of the present disclosure. The figure also shows the resulting correlation function 1010 and discriminator function 1020 generated by the signal decoder 180 when SGC is employed.

The first plot 1010 shows the correlation function 617 without beamforming or jamming (e.g., passthrough), along with the correlation function 1015 under jamming conditions after beamforming with SGC. These plots show that the beamformer increases gain on the SOI (e.g., the correlation peaks are higher), and the SGC avoids shifting the locations of the correlation peaks and zeros, solving the problem seen previously in FIG. 6.

The second plot 1020 shows the discriminator output 627 without beamforming or jamming (e.g., passthrough) 627 along with the discriminator output 1025 under jamming conditions after beamforming without SGC. In this case, then, it can be seen that the SGC technique results in a discriminator function 1025 having a single zero crossing (at code phase m=0) which allows the code phase detector to lock in on the correct code phase.

### Methodology

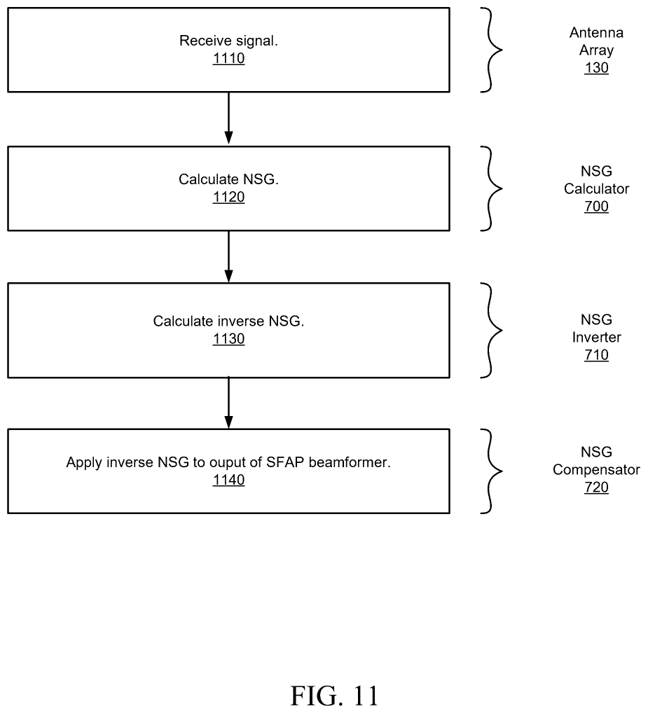

FIG. 11 is a flowchart illustrating a methodology 1100 for providing SGC, in accordance with an embodiment of the present disclosure. As can be seen, example method 1100 includes a number of phases and sub-processes, the sequence of which may vary from one embodiment to another. However, when considered in aggregate, these phases and sub-processes form a process for operation of the beamforming receiver 100 configured to provide SGC, in accordance with certain of the embodiments disclosed herein, for example as illustrated in FIGS. 1-9, as described above. However other system architectures can be used in other embodiments, as will be apparent in light of this disclosure. To this end, the correlation of the various functions shown in FIG. 11 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 1100 commences, at operation 1110, by receiving a signal at an antenna array.

At operation 1120, an NSG is calculated at each of a plurality of frequencies. The NSG calculation is based on steering constraints provided to SFAP beamformer and on beamforming weights generated by the SFAP beamformer. In some embodiments, the plurality of frequencies spans a frequency range associated with jamming signals to be nulled by the SFAP beamformer.

In some embodiments, the NSG is calculated as a magnitude of a dot product of the beamformer steering constraint vector and the beamforming weight vector, which is then normalized by a vector norm of the steering constraint vector and a vector norm of the beamforming weight vector.

At operation 1130, an inverse of the NSG is calculated at each of the plurality of frequencies.

At operation 1140, the output of the SFAP beamformer is multiplied with the inverse of the NSG to generate a steering gain compensated beamformer output, at each of the plurality of frequencies.

In some embodiments, additional operations may be performed, as previously described in connection with the system. For example, the inverse of the NSG may be scaled by a scale factor that is selected to achieve a tradeoff between the beamforming gain on the signal of interest versus the suppression of jamming signals. In some embodiments, the scale factor is frequency dependent.

### Example System

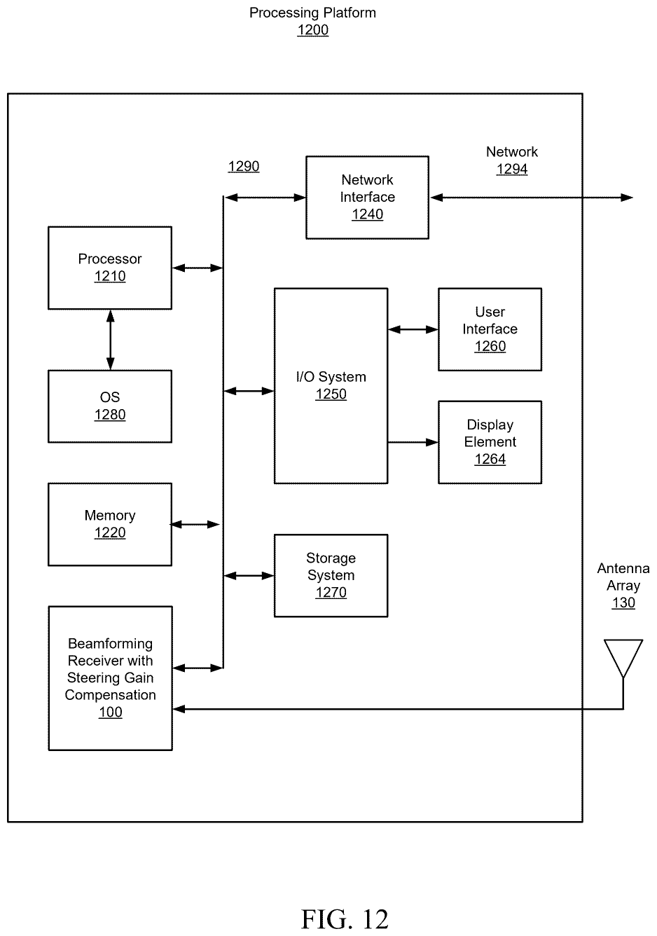

FIG. 12 is a block diagram of a processing platform 1200 configured to provide SGC, in accordance with an embodiment of the present disclosure. In some embodiments, platform 1200, or portions thereof, may be hosted on, or otherwise be incorporated into the electronic systems of an aircraft, ship, ground station, or man-portable system deployment.

In some embodiments, platform 1200 may comprise any combination of a processor 1210, memory 1220, a network interface 1240, an input/output (I/O) system 1250, a user interface 1260, a display element 1264, a storage system 1270, beamforming receiver 100, and antenna array 130. As can be further seen, a bus and/or interconnect 1290 is also provided to allow for communication between the various components listed above and/or other components not shown. Platform 1200 can be coupled to a network 1294 through network interface 1240 to allow for communications with other computing devices, platforms, devices to be controlled, or other resources. Other componentry and functionality not reflected in the block diagram of FIG. 12 will be apparent in light of this disclosure, and it will be appreciated that other embodiments are not limited to any particular hardware configuration.

Processor 1210 can be any suitable processor, and may include one or more coprocessors or controllers, such as an audio processor, a graphics processing unit, or hardware accelerator, to assist in the execution of mission software and/or any control and processing operations associated with platform 1200, including operation of the beamforming receiver 100. In some embodiments, the processor 1210 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 1210 may be implemented as a complex instruction set computer (CISC) or a reduced instruction set computer (RISC) processor. In some embodiments, processor 1210 may be configured as an ×86 instruction set compatible processor.

Memory 1220 can be implemented using any suitable type of digital storage including, for example, flash memory and/or random access memory (RAM). In some embodiments, the memory 1220 may include various layers of memory hierarchy and/or memory caches as are known to those of skill in the art. Memory 1220 may be implemented as a volatile memory device such as, but not limited to, a RAM, dynamic RAM (DRAM), or static RAM (SRAM) device. Storage system 1270 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 1210 may be configured to execute an Operating System (OS) 1280 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 1200, and therefore may also be implemented using any suitable existing or subsequently-developed platform.

Network interface circuit 1240 can be any appropriate network chip or chipset which allows for wired and/or wireless connection between other components of platform 1200 and/or network 1294, thereby enabling platform 1200 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 1250 may be configured to interface between various I/O devices and other components of platform 1200. I/O devices may include, but not be limited to, user interface 1260 and display element 1264. User interface 1260 may include devices (not shown) such as a touchpad, cockpit display unit, keyboard, and mouse, etc., for example, to allow the user to control the system. Display element 1264 may be configured to display information to a user. I/O system 1250 may include a graphics subsystem configured to perform processing of images for rendering on the display element 1264. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 1210 or any chipset of platform 1200.

It will be appreciated that in some embodiments, the various components of platform 1200 may be combined or integrated in a system-on-a-chip (SoC) architecture. In some embodiments, the components may be hardware components, firmware components, software components or any suitable combination of hardware, firmware, or software.

Beamforming receiver 100 is configured to provide SGC for SFAP beamforming, as described previously. Beamforming receiver 100 may include any or all of the circuits/components illustrated in FIGS. 1-9, as described above. These components can be implemented or otherwise used in conjunction with a variety of suitable software and/or hardware that is coupled to or that otherwise forms a part of platform 1200. These components can additionally or alternatively be implemented or otherwise used in conjunction with user I/O devices that are capable of providing information to, and receiving information and commands from, a user.

In various embodiments, platform 1200 may be implemented as a wireless system, a wired system, or a combination of both. When implemented as a wireless system, platform 1200 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 1200 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 1294. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 1200 may comprise additional, fewer, or alternative subcomponents as compared to those included in the example embodiment of FIG. 12.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a steering gain compensation system comprising: a normalized steering gain (NSG) calculator configured to calculate an NSG, at each of a plurality of frequencies, based on steering constraints provided to a space-frequency adaptive processing (SFAP) beamformer and on beamforming weights generated by the SFAP beamformer; an NSG inverter configured to calculate an inverse of the NSG, at each of the plurality of frequencies; and an NSG compensator configured to multiply an output of the SFAP beamformer with the inverse of the NSG to generate a steering gain compensated beamformer output, at each of the plurality of frequencies.

Example 2 includes the system of Example 1, wherein the NSG calculator is configured to calculate the NSG as a magnitude of a dot product of a steering constraint vector representing the steering constraints and a beamforming weight vector representing the beamforming weights, the dot product normalized by a vector norm of the steering constraint vector and a vector norm of the beamforming weight vector.

Example 3 includes the system of Example 2, wherein a length of the beamforming weight vector is equal to a number of antenna elements configured to provide inputs to the SFAP beamformer.

Example 4 includes the system of any of Examples 1-3, wherein the plurality of frequencies spans a frequency range associated with a signal of interest to be processed by the SFAP beamformer.

Example 5 includes the system of any of Examples 1-4, wherein the NSG inverter is configured to scale the inverse of the NSG by a scale factor, the scale factor selected to balance between beamforming gain on a signal of interest versus suppression of jamming signals.

Example 6 includes the system of Example 5, wherein the scale factor is frequency dependent.

Example 7 includes the system of Example 5, wherein the signal of interest is a global positioning system signal.

Example 8 is a computer program product including one or more non-transitory machine-readable mediums encoded with instructions that when executed by one or more processors cause a process to be carried out for steering gain compensation, the process comprising: receiving a signal at an antenna array; calculating a normalized steering gain (NSG), at each of a plurality of frequencies, based on steering constraints provided to a space-frequency adaptive processing (SFAP) beamformer and on beamforming weights generated by the SFAP beamformer to be applied to the received signal; calculating an inverse of the NSG, at each of the plurality of frequencies; and multiplying an output of the SFAP beamformer with the inverse of the NSG to generate a steering gain compensated beamformer output, at each of the plurality of frequencies.

Example 9 includes the computer program product of Example 8, wherein the process comprises calculating the NSG as a magnitude of a dot product of a steering constraint vector representing the steering constraints and a beamforming weight vector representing the beamforming weights, the dot product normalized by a vector norm of the steering constraint vector and a vector norm of the beamforming weight vector.

Example 10 includes the computer program product of Example 9, wherein a length of the beamforming weight vector is equal to a number of antenna elements of the antenna array configured to provide inputs to the SFAP beamformer.

Example 11 includes the computer program product of any of Examples 8-10, wherein the plurality of frequencies spans a frequency range associated with a signal of interest to be processed by the SFAP beamformer.

Example 12 includes the computer program product of any of Examples 8-11, wherein the process comprises scaling the inverse of the NSG by a scale factor, the scale factor selected to balance between beamforming gain on a signal of interest versus suppression of jamming signals.

Example 13 includes the computer program product of Example 12, wherein the scale factor is frequency dependent.

Example 14 includes the computer program product of Example 12, wherein the signal of interest is a global positioning system signal.

Example 15 is a method for steering gain compensation, the method comprising: receiving a signal at an antenna array; calculating a normalized steering gain (NSG), at each of a plurality of frequencies, based on steering constraints provided to a space-frequency adaptive processing (SFAP) beamformer and on beamforming weights generated by the SFAP beamformer to be applied to the received signal; calculating an inverse of the NSG, at each of the plurality of frequencies; and multiplying an output of the SFAP beamformer with the inverse of the NSG to generate a steering gain compensated beamformer output, at each of the plurality of frequencies.

Example 16 includes the method of Example 15, comprising calculating the NSG as a magnitude of a dot product of a steering constraint vector representing the steering constraints and a beamforming weight vector representing the beamforming weights, the dot product normalized by a vector norm of the steering constraint vector and a vector norm of the beamforming weight vector.

Example 17 includes the method of Example 16, wherein a length of the beamforming weight vector is equal to a number of antenna elements of the antenna array configured to provide inputs to the SFAP beamformer.

Example 18 includes the method of any of Examples 15-17, wherein the plurality of frequencies spans a frequency range associated with a signal of interest to be processed by the SFAP beamformer.

Example 19 includes the method of any of Examples 15-18, comprising scaling the inverse of the NSG by a scale factor, the scale factor selected to balance between beamforming gain on a signal of interest versus suppression of jamming signals.

Example 20 includes the method of Example 19, wherein the scale factor is frequency dependent, and the signal of interest is a global positioning system signal.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A steering gain compensation system comprising:
a normalized steering gain (NSG) calculator configured to calculate an NSG, at each of a plurality of frequencies, based on steering constraints provided to a space-frequency adaptive processing (SFAP) beamformer and on beamforming weights generated by the SFAP beamformer;
an NSG inverter configured to calculate an inverse of the NSG, at each of the plurality of frequencies; and
an NSG compensator configured to multiply an output of the SFAP beamformer with the inverse of the NSG to generate a steering gain compensated beamformer output, at each of the plurality of frequencies.

2. The system of claim 1, wherein the NSG calculator is configured to calculate the NSG as a magnitude of a dot product of a steering constraint vector representing the steering constraints and a beamforming weight vector representing the beamforming weights, the dot product normalized by a vector norm of the steering constraint vector and a vector norm of the beamforming weight vector.

3. The system of claim 2, wherein a length of the beamforming weight vector is equal to a number of antenna elements configured to provide inputs to the SFAP beamformer.

4. The system of claim 1, wherein the plurality of frequencies spans a frequency range associated with a signal of interest to be processed by the SFAP beamformer.

5. The system of claim 1, wherein the NSG inverter is configured to scale the inverse of the NSG by a scale factor, the scale factor selected to balance between beamforming gain on a signal of interest versus suppression of jamming signals.

6. The system of claim 5, wherein the scale factor is frequency dependent.

7. The system of claim 5, wherein the signal of interest is a global positioning system signal.

8. A computer program product including one or more non-transitory machine-readable mediums encoded with instructions that when executed by one or more processors cause a process to be carried out for steering gain compensation, the process comprising:
receiving a signal at an antenna array;
calculating a normalized steering gain (NSG), at each of a plurality of frequencies, based on steering constraints provided to a space-frequency adaptive processing (SFAP) beamformer and on beamforming weights generated by the SFAP beamformer to be applied to the received signal;
calculating an inverse of the NSG, at each of the plurality of frequencies; and
multiplying an output of the SFAP beamformer with the inverse of the NSG to generate a steering gain compensated beamformer output, at each of the plurality of frequencies.

9. The computer program product of claim 8, wherein the process comprises calculating the NSG as a magnitude of a dot product of a steering constraint vector representing the steering constraints and a beamforming weight vector representing the beamforming weights, the dot product normalized by a vector norm of the steering constraint vector and a vector norm of the beamforming weight vector.

10. The computer program product of claim 9, wherein a length of the beamforming weight vector is equal to a number of antenna elements of the antenna array configured to provide inputs to the SFAP beamformer.

11. The computer program product of claim 8, wherein the plurality of frequencies spans a frequency range associated with a signal of interest to be processed by the SFAP beamformer.

12. The computer program product of claim 8, wherein the process comprises scaling the inverse of the NSG by a scale factor, the scale factor selected to balance between beamforming gain on a signal of interest versus suppression of jamming signals.

13. The computer program product of claim 12, wherein the scale factor is frequency dependent.

14. The computer program product of claim 12, wherein the signal of interest is a global positioning system signal.

15. A method for steering gain compensation, the method comprising:
receiving a signal at an antenna array;
calculating a normalized steering gain (NSG), at each of a plurality of frequencies, based on steering constraints provided to a space-frequency adaptive processing (SFAP) beamformer and on beamforming weights generated by the SFAP beamformer to be applied to the received signal;
calculating an inverse of the NSG, at each of the plurality of frequencies; and
multiplying an output of the SFAP beamformer with the inverse of the NSG to generate a steering gain compensated beamformer output, at each of the plurality of frequencies.

16. The method of claim 15, comprising calculating the NSG as a magnitude of a dot product of a steering constraint vector representing the steering constraints and a beamforming weight vector representing the beamforming weights, the dot product normalized by a vector norm of the steering constraint vector and a vector norm of the beamforming weight vector.

17. The method of claim 16, wherein a length of the beamforming weight vector is equal to a number of antenna elements of the antenna array configured to provide inputs to the SFAP beamformer.

18. The method of claim 15, wherein the plurality of frequencies spans a frequency range associated with a signal of interest to be processed by the SFAP beamformer.

19. The method of claim 15, comprising scaling the inverse of the NSG by a scale factor, the scale factor selected to balance between beamforming gain on a signal of interest versus suppression of jamming signals.

20. The method of claim 19, wherein the scale factor is frequency dependent, and the signal of interest is a global positioning system signal.
